(19) United States
(12) Patent Application Publication
(10) Pub. No.: US 2026/0332704 A1
(43) Pub. Date: Oct. 22, 2026

(54) SHEET FEEDING APPARATUS, IMAGE READING APPARATUS, AND IMAGE FORMING APPARATUS

(71) Applicant: CANON KABUSHIKI KAISHA, Tokyo (JP)

(72) Inventor: MASATO FURUKAWA, Chiba (JP)

(21) Appl. No.: 19/560,691

(22) Filed: Mar. 9, 2026

(30) Foreign Application Priority Data
Mar. 11, 2025 (JP) 2025-038774

(51) Int. Cl. H04N 1/00; G03G 15/00; G03G 15/22; H04N 1/12

(52) U.S. Cl. CPC H04N 1/00037; G03G 15/228; G03G 15/5016; G03G 15/6511; G03G 15/70; H04N 1/00076; H04N 1/00082; H04N 1/00824; H04N 1/1215; G03G 2215/00548; G03G 2215/00556; G03G 2215/00607; H04N 2201/0094

(57) ABSTRACT

A sheet feeding apparatus includes a sheet support unit configured to support a sheet, a sheet feeding unit including a rotary feeding member configured to feed the sheet supported by the sheet support unit, and a driving unit configured to drive the rotary feeding member, a control unit configured to control the driving unit, and an output unit configured to output information. In a case where it is determined that feeding of the sheet by the sheet feeding unit is defective and a value corresponding to a torque generated in the driving unit during feeding of the sheet is greater than a threshold value, the control unit is configured to output information on a notification prompting inspection, by the output unit.

### BACKGROUND

### Field of the Technology

The present disclosure relates to a sheet feeding apparatus that feeds sheets, an image reading apparatus, and an image forming apparatus.

### Description of the Related Art

An image reading apparatus has been proposed in which an area sensor monitors the movement of the outermost document in the sheet feed tray, and in a case where it is determined that the document does not move even when the pickup roller is rotated in the feed direction, the pickup roller is rotated in the reverse direction (see Japanese Patent Application Laid-Open Publication No. 2021-181363). In addition, an image forming apparatus has been proposed that determines that an abnormality has occurred in a case where the absolute value of a parameter corresponding to the load torque applied to the motor that drives the roller is not within a reference value (see Japanese Patent Application Laid-Open Publication No. 2020-177054).

Incidentally, in a case where it is determined that the sheet feeding is defective, there is a high possibility that some abnormality has occurred. In such a case, if the next sheet is fed without noticing the abnormality, the possibility of the sheet jamming increases.

### SUMMARY

Accordingly, the present disclosure provides a sheet feeding apparatus, an image reading apparatus, and an image forming apparatus that are capable of reducing the sheet jamming.

According to a first aspect of the present disclosure, a sheet feeding apparatus includes a sheet support unit configured to support a sheet, a sheet feeding unit including a rotary feeding member configured to feed the sheet supported by the sheet support unit, and a driving unit configured to drive the rotary feeding member, a control unit configured to control the driving unit, and an output unit configured to output information. In a case where it is determined that feeding of the sheet by the sheet feeding unit is defective and a value corresponding to a torque generated in the driving unit during feeding of the sheet is greater than a threshold value, the control unit is configured to output information on a notification prompting inspection, by the output unit.

According to a second aspect of the present disclosure, a sheet feeding apparatus includes a sheet support unit configured to support a sheet, a sheet feeding unit including a rotary feeding member configured to feed the sheet supported by the sheet support unit, and a driving unit configured to drive the rotary feeding member, a control unit configured to control the driving unit, a drive control unit configured to control the driving unit by generating a control current to be applied to the driving unit based on a command value input from the control unit, and an output unit configured to output information. In a case where it is determined that feeding of the sheet by the sheet feeding unit is defective and the control current during the feeding of the sheet is greater than a threshold value, the control unit is configured to output information on a notification prompting inspection, by the output unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view showing a printer according to a first embodiment.

FIG. 2 is a schematic cross-sectional view showing an image reading apparatus according to the first embodiment.

FIG. 3 is a block diagram showing the configuration of a control system of the image reading apparatus according to the first embodiment.

FIG. 4 is a diagram illustrating vector control of a motor.

FIG. 5 is a block diagram showing the control functions of a motor control device.

FIG. 6 is a flowchart showing control of a reading job.

FIG. 7 is a flowchart showing feeding control according to the first embodiment.

FIG. 8 is a diagram showing the conveyance torque measured when feeding a document in a case where the document cannot be advanced due to a foreign substance.

FIG. 9 is an enlarged cross-sectional view showing an ADF in a case where a document cannot be advanced due to a foreign substance.

FIG. 10 is a diagram showing the conveyance torque measured in a case where the document has not been fed.

FIG. 11 is a diagram showing an example of a foreign substance inspection screen.

FIG. 12 is a diagram showing an example of a document inspection screen.

FIG. 13 is a flowchart showing a feeding control according to a second embodiment.

FIG. 14 is a diagram showing a current value of a torque current component measured when feeding a document in a case where the document cannot be advanced due to a foreign substance.

FIG. 15 is a diagram showing a current value of a torque current component measured in a case where a document has not been fed.

### DESCRIPTION OF THE EMBODIMENTS

### First Embodiment

Hereinafter, an image reading apparatus and an image forming apparatus according to a first embodiment will be described with reference to the drawings. It should be noted that the dimensions, materials, shapes, relative positions, etc. of the components described in the following embodiments are not intended to limit the scope of application of the present technology to only those unless otherwise specified.

### Printer Configuration

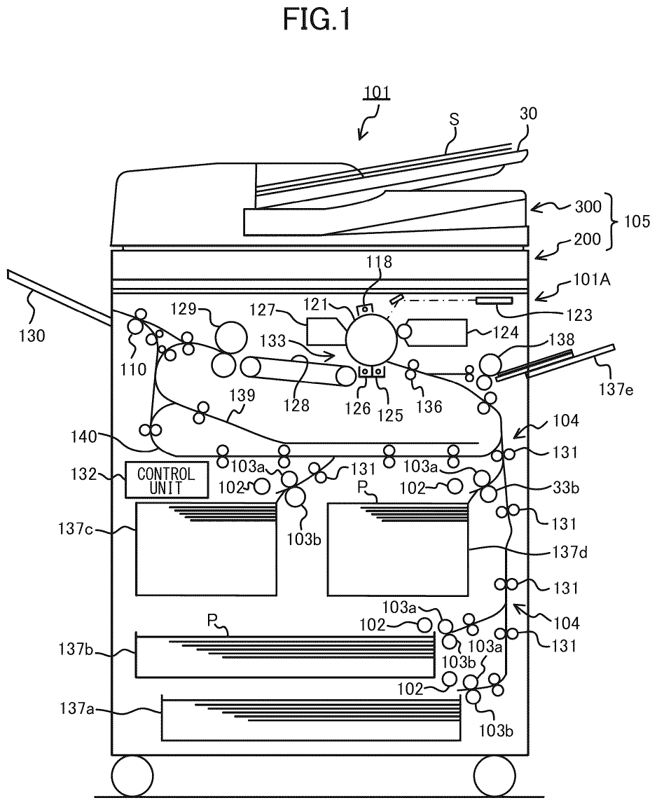

First, the configuration of a printer 101 serving as an image forming apparatus according to the first embodiment will be described with reference to FIG. 1. FIG. 1 is a schematic cross-sectional view showing a printer according to the first embodiment.

As shown in FIG. 1, the printer 101 includes a printer main body 101A and an image reading apparatus 105. The image reading apparatus 105 disposed above the printer main body 101A includes an image reading unit 200 and an automatic document feeder (hereinafter referred to as “ADF”) 300 serving as a sheet feeding apparatus, and optically scans the document S to read image information. The image information converted into an electrical signal by the image reading apparatus 105 is transferred to a control unit 132 provided in the printer main body 101A. As a result, the printer 101 forms an image on a recording medium based on the image information read by the image reading apparatus 105.

The printer main body 101A has an image forming unit 133 that forms an image on a sheet P, which is a recording medium, and a sheet feeding unit 104 that feeds the sheet P to the image forming unit 133. The sheet feeding unit 104 includes sheet storage portions 137a, 137b, 137c, and 137d that can store sheets of different sizes. The sheets stored in each sheet storage portion are picked up by a pickup roller 102, separated one by one by a feed roller 103a and a retard roller 103b, and delivered to the corresponding conveyance roller pair 131. The sheet P is then conveyed to a pair of registration rollers 136 by being delivered in order to a plurality of conveyance roller pairs 131 disposed along the sheet conveyance path.

The sheet P placed on the manual feed tray 137e by the user is fed into the printer main body 101A by a feed roller 138 and conveyed to the pair of registration rollers 136. The pair of registration rollers 136 stops the leading edge of the sheet P to correct the skew, and resumes conveyance of the sheet P in accordance with the progress of the image forming operation, which is the toner image forming process, by the image forming unit 133.

The image forming unit 133 that forms an image on the sheet P is an electrophotographic system unit including a photosensitive drum 121 that is a photosensitive member. The photosensitive drum 121 is rotatable along the conveying direction of the sheet P, and a charger 118, an exposing unit 123, a developing unit 124, a transfer charger 125, a separation charger 126, and a cleaner 127 are arranged around the photosensitive drum 121. The charger 118 uniformly charges the surface of the photosensitive drum 121. The exposing unit 123 exposes the photosensitive drum 121 based on image information input from the image reading apparatus 105 or the like, and forms an electrostatic latent image on the photosensitive drum 121.

The developing unit 124 contains a two-component developer containing toner and carrier, and supplies charged toner to the photosensitive drum 121 to develop the electrostatic latent image into a toner image. The toner image carried on the photosensitive drum 121 is transferred onto the sheet P conveyed from the pair of registration rollers 136 by a bias electric field formed by the transfer charger 125. The sheet P onto which the toner image is transferred is separated from the photosensitive drum 121 by a bias electric field formed by the separation charger 126, and is conveyed by a pre-fixing conveyance unit 128 toward a fixing unit 129. Further, any deposits such as residual toner remaining on the photosensitive drum 121 without being transferred onto the sheet P are removed by the cleaner 127, and the photosensitive drum 121 prepares for the next image forming operation.

The sheet P conveyed to the fixing unit 129 is sandwiched between a pair of rollers and heated while being pressed, so that the toner is melted and fixed, thereby fixing the image. In a case where the image output is completed, the sheet P on which the fixed image is formed is discharged via a discharge roller pair 110 onto a discharge tray 130 that protrudes outward from the printer main body 101A. In a case where an image is formed on the back side of the sheet P in double-sided printing, the sheet P that has passed through the fixing unit 129 has its front and back sides swapped by the reverse portion 139 and is conveyed to the pair of registration rollers 136 by the double-sided conveyance unit 140. Then, the sheet P on which the image has been formed again by the image forming unit 133 is discharged onto the discharge tray 130.

The image forming unit 133 is an example of an image forming unit, and for example, an inkjet type image forming unit or an offset printing type printing mechanism may be used as the image forming unit.

### Configuration of Image Reading Apparatus

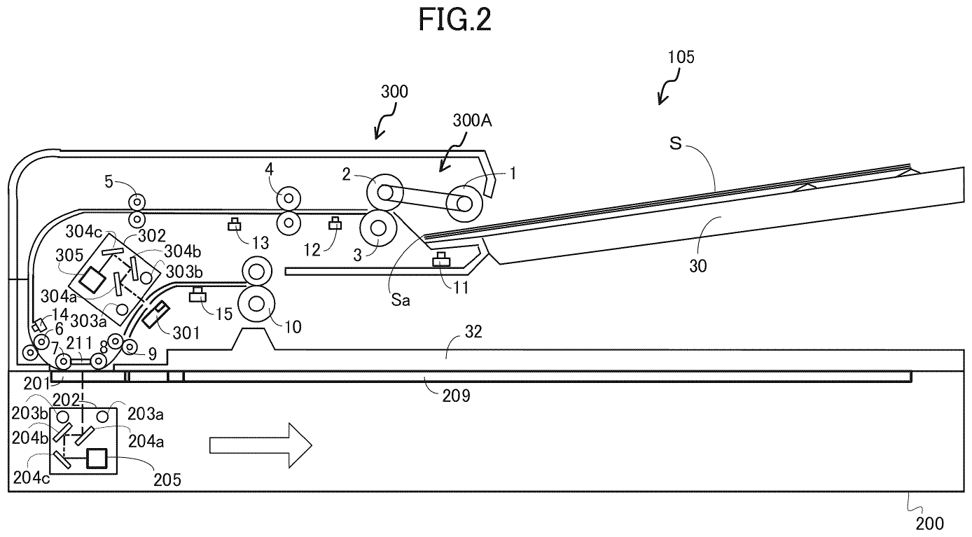

Next, the details of the configuration of the image reading apparatus 105 according to the first embodiment will be described with reference to FIG. 2. FIG. 2 is a schematic cross-sectional view showing an image reading apparatus according to the first embodiment. As described above, the image reading apparatus 105 includes an image reading unit 200 that reads an image of a document, and an ADF 300.

### Configuration of Image Reading Unit

First, the image reading unit 200 will be described with reference to FIG. 2. The image reading unit 200 includes an optical scanner unit 202 serving as a reading unit, and a document placement glass 209. The optical scanner unit 202 performs scanning in the sub-scanning direction (arrow F) at a constant speed, and reads the document S placed on the document placement glass 209 line by line (fixed reading). After the optical scanner unit 202 moves to the center position of a front glass facing member 211, the optical scanner unit 202 optically reads the document S fed and conveyed by the ADF 300 (document feeding-reading).

That is, the optical scanner unit 202 includes LEDs 203a and 203b, mirrors 204a, 204b and 204c, and a front side image reading sensor 205. In fixed reading, these LEDs 203a and 203b irradiate light onto the document S placed on the document placement glass 209, and in document feeding-reading, they irradiate light as the document S passes between a document feeding-reading glass 201 and the front glass facing member 211. The reflected light of the light emitted by the LEDs 203a and 203b is bent by the mirrors 204a, 204b, and 204c and enters the front side image reading sensor 205. The front side image reading sensor 205 is configured with a sensor using optical elements such as a Complementary metal-oxide-semiconductor (CMOS) or a Charge Coupled Device (CCD). The front side image reading sensor 205 then reads the image of the document S line by line based on the incident light.

### ADF Configuration

Next, the ADF 300 will be described with reference to FIG. 2. As shown in FIG. 2, the ADF 300 includes a document tray 30 serving as a sheet supporting portion on which a stack of documents S consisting of one or more sheets is supported and stacked, and a document feeding portion 300A serving as a sheet feeding unit that feeds the documents S supported on the document tray 30. The document feeding portion 300A also has an upper separation roller 2 and a lower separation roller 3, which restrict the advance of the document S downstream of the document tray 30 before the document S is fed, and a feed roller (pickup roller) 1. Inside the main body of the ADF 300 and below the document tray 30, a document presence/absence detection sensor 11 is provided to detect the presence or absence of documents S stacked on the document tray 30. In this embodiment, the documents S stacked on the document tray 30 are assumed to be sheet-shaped, and can also be called sheets. In this embodiment, the feed roller 1 and the upper separation roller 2 are driven by a separation motor 805 serving as a driving unit, which will be described later, and configure a rotary feeding member that feeds the sheet.

When reading and conveying the documents, in order to reliably convey the documents stacked on the document tray 30, it is necessary to bring the feed roller 1 into contact with the topmost document S on the document tray 30 and create a state in which an appropriate pressure is applied to the contacting portion. Therefore, the document tray 30 is raised to a certain height. Then, the feed roller 1 descends toward the documents S stacked on the document tray 30 and rotates to feed the topmost document S. That is, the feed roller 1 is pressed against the topmost document S stacked on the document tray 30, and the feed roller 1 is rotated in this state, whereby the topmost document in the document stack is conveyed. With respect to the documents S fed by the feed roller 1, only one topmost document among the plurality of documents S is separated and conveyed by the action of the upper separation roller 2 and the lower separation roller 3. Then, the document S is conveyed by the pull-out rollers 4 and 5 toward the document feeding-reading glass 201 via a lead roller 6 provided downstream of the pull-out roller 5 in the feeding direction of the document S.

The document S conveyed onto the upper surface of the document feeding-reading glass 201 is conveyed by the lead roller 6 and the guide plate upstream roller 7, while the image on the surface is read by the optical scanner unit 202. In a case where only the image on the front side of the document S is to be read, the document S is conveyed by the guide plate downstream roller 8, passes through the back side reading conveyance roller 9, and is discharged onto a discharge tray 32 by a discharge roller 10.

Inside the ADF 300, an optical scanner unit 302 serving as a reading unit for reading the back side is provided. In a case of reading an image on the back side of the document S, after reading the image on the front side, the document S is conveyed to the upper surface of a back glass facing member 301, and the image on the back side, which is opposite to the side read by the optical scanner unit 202, is read by the optical scanner unit 302. That is, the optical scanner unit 302 includes LEDs 303a and 303b, mirrors 304a, 304b and 304c, and a back side image reading sensor 305. These LEDs 303a and 303b emit light when the document S passes through the back glass facing member 301. The reflected light of light emitted by the LEDs 303a and 303b is bent by the mirrors 304a, 304b, and 304c and enters the back side image reading sensor 305. The back side image reading sensor 305 reads the image on the back side of the document S line by line using the incident light. The back side image reading sensor 305 is also configured with a sensor using optical elements such as a CMOS or a CCD. The document S, whose back side image has been read, is discharged onto the discharge tray 32 by the discharge roller 10.

In addition, the ADF 300 is provided with a separation sensor 12 serving as a sheet detection unit having a detection position for the document S downstream of the upper separation roller 2 and the lower separation roller 3 and upstream of the pull-out roller 4 in the feeding direction in which the document S is fed. When this separation sensor 12 detects the document S, for example, within a set time from the start of the feeding job, the CPU (A) 801 described below can determine that the document S has been fed normally by the upper separation roller 2 and the lower separation roller 3. In other words, because the document S cannot be detected within the set time, the CPU (A) 801 can determine that the document S is not being fed by the upper separation roller 2 and the lower separation roller 3, which means that a feeding failure has occurred.

Similarly, the ADF 300 is provided with a pull-out sensor 13 of which a detection position for detecting the document S is downstream of the pull-out roller 4 and upstream of the pull-out roller 5 in the feeding direction. Further, the ADF 300 is provided with a lead sensor 14 of which a detection position for detecting the document S is downstream of the pull-out roller 5 and upstream of the lead roller 6 in the feeding direction. The ADF 300 is provided with a discharge sensor 15 having a detection position for detecting the document S upstream of the discharge roller 10 in the feeding direction. Each of these sensors can also detect the document S within a set time from the start of a feeding job, for example, so that the CPU (A) 801 can determine that the document S has been fed normally. In other words, because the document S cannot be detected within the set time, the CPU (A) 801 can determine that the document S is not being fed, which means that a feeding failure has occurred.

### Configuration of Control System of Image Reading Apparatus

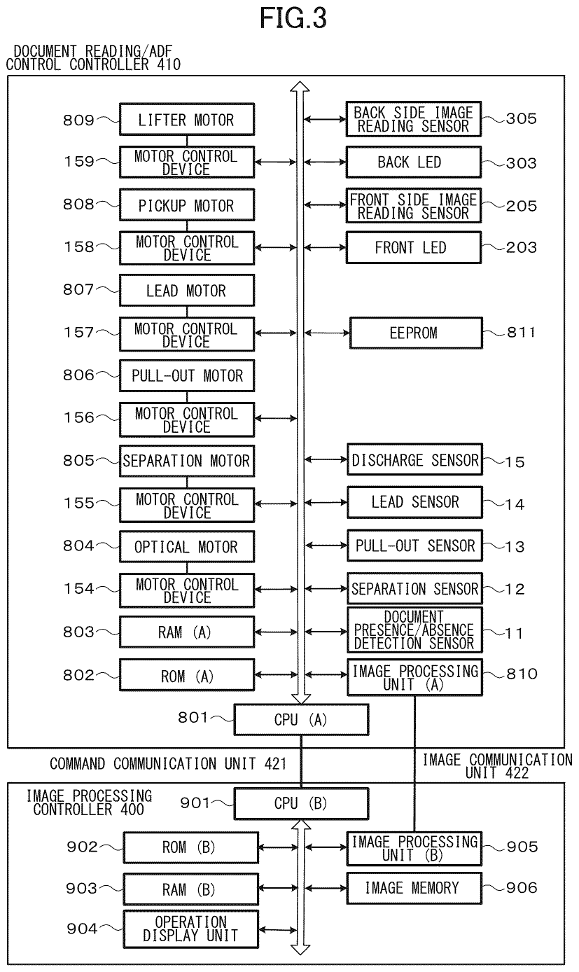

Next, the configuration of the control system of the image reading apparatus 105 will be described with reference to FIG. 3. FIG. 3 is a block diagram showing the configuration of the control system of the image reading apparatus according to the first embodiment.

An image processing controller 400 shown in FIG. 3 is in the control unit 132 (see FIG. 1) disposed in the printer main body 101A of the printer 101, and the image reading/ADF control controller 410 is the configuration of a control system disposed in the image reading apparatus 105. Furthermore, in this embodiment, the control unit that performs the reading job control and the feeding control, which will be described in detail later, is executed by the CPU (A) 801, so that the CPU (A) 801 functions as the control unit. The control unit 132 also includes an image formation controller (not shown) that executes control related to image formation.

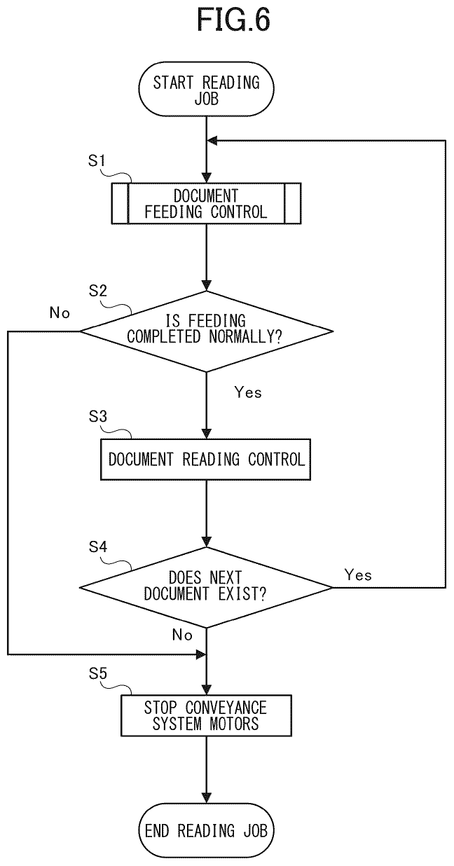

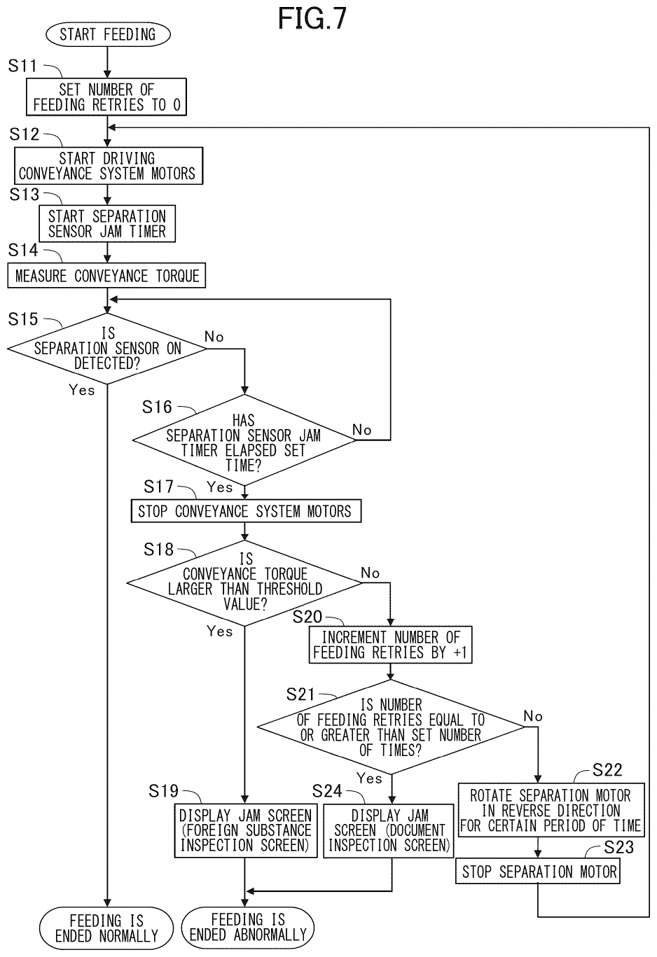

The document reading/ADF control controller 410 includes a CPU (A) 801 which is a central processing unit, a ROM (A) 802 which is a read-only memory, and a RAM (A) 803 which is a random access memory. The ROM (A) 802 stores a control program, and the RAM (A) 803 stores input data and working data. The CPU (A) 801 serving as a control unit executes a control program in accordance with the flowcharts shown in FIGS. 6 and 7.

In order to implement the document feeding function of the ADF 300, the separation motor 805 is connected to the feed roller 1 and the upper separation roller 2 to rotate these rollers. The separation motor 805 is controlled by the motor control device 155 based on a command from the CPU (A) 801. In this embodiment, the upper separation roller 2 configures a rotary feeding member, and the separation motor 805 configures a driving unit.

Similarly, in order to implement the document conveyance function, a pull-out motor 806 is connected to the pull-out rollers 4 and 5 to rotate them. Furthermore, in order to implement the document conveyance function, a lead motor 807 is connected to the lead roller 6, the guide plate upstream roller 7, the guide plate downstream roller 8, the back side reading conveyance roller 9, and the discharge roller 10 to rotate them. The pull-out motor 806 is controlled by the motor control device 156 based on a command from the CPU (A) 801, and the lead motor 807 is controlled by the motor control device 157 based on a command from the CPU (A) 801.

Further, a pickup motor 808 is connected to a roller lifting mechanism including an elliptical cam (not shown) and raises or lowers the feed roller 1. That is, the pickup motor 808 can raise the feed roller 1 so as to separate it from a topmost document D, and lower the feed roller 1 so as to abut against the topmost document D. The pickup motor 808 is controlled by the motor control device 158 based on a command from the CPU (A) 801.

A lifter motor 809 is connected to a tray lifting mechanism (not shown) to raise or lower the document tray 30. That is, when a document is placed on the document tray 30, the lifter motor 809 raises the document tray 30 to a certain height, and presses the lowered feed roller 1 against the upper surface of the topmost document S stacked on the document tray 30. The lifter motor 809 is controlled by the motor control device 159 based on a command from the CPU (A) 801.

Furthermore, to implement the image reading function, the CPU (A) 801 is connected to the front LED 203 and the front side image reading sensor 205 mounted on the front side optical scanner unit 202. Furthermore, the CPU (A) 801 is connected to the back LED 303 and the back side image reading sensor 305 mounted on the back optical scanner unit 302 for back side reading. The CPU (A) 801 reads image data using the front side image reading sensor 205 and/or the back side image reading sensor 305. The read data undergoes a shading process and various filtering processes in the image processing unit (A) 810 and is then transmitted to the image processing controller 400 via the image communication unit 422. In addition, the image processing unit (A) 810 is equipped with a function of correcting the amount of inclination of the document S, and can correct the inclination of the read image without using a registration technology of reducing the physical skew of the document S.

Furthermore, the CPU (A) 801 notifies the image processing controller 400 via the image communication unit 422 of a vertical synchronization signal that serves as the reference for the leading edge of the document image data and a horizontal synchronization signal that serves as the reference for the leading edge of one line of pixels in accordance with the timing of reading the document.

The image processing controller 400 includes a CPU (B) 901, a ROM (B) 902, and a RAM (B) 903, and exchanges data relating to image reading control with the CPU (A) 801 via a command communication unit 421. The image data processed by the image processing unit (A) 810 is transferred to the image processing unit (B) 905 of the image processing controller 400 via the image communication unit 422, and after undergoing predetermined image processing such as color determination, is stored in the image memory 906. The image processing controller 400 also includes an operation display unit 904 serving as an output unit or display unit, and interface control for accepting user operations is performed by the CPU (B) 901 via the operation display unit 904. The CPU (B) 901 receives information input by the user to the operation display unit 904 and processes the input information such as reading job start.

### Motor Vector Control

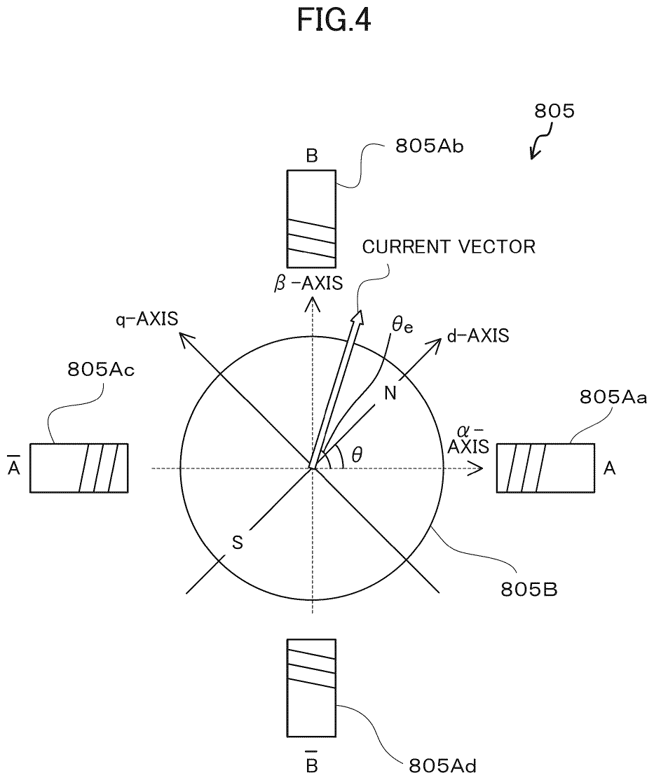

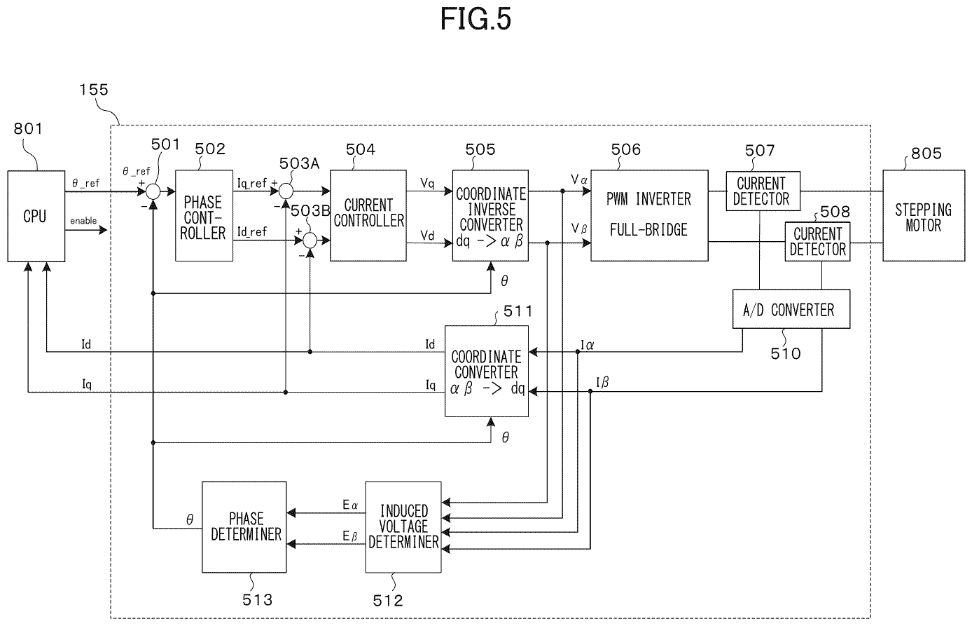

Next, vector control of the motor according to this embodiment will be described with reference to FIGS. 4 and 5. FIG. 4 is a diagram illustrating vector control of a motor. FIG. 5 is a block diagram showing the control functions of a motor control device. In the following description of vector control, the motor control device 155 that performs vector control of the separation motor 805 will be described as an example, but the same applies to the motor control devices 154, 156, 157, 158, and 159, so their description will be omitted. Furthermore, although the separation motor 805 in the following description is not provided with a sensor such as a rotary encoder for detecting the rotational phase of the rotor 805B, it may be provided with a sensor such as a rotary encoder to detect the rotational phase.

FIG. 4 is a diagram showing the relationship between the separation motor 805, which is a stepping motor consisting of two phases, A phase (first phase) and B phase (second phase), and a rotating coordinate system represented by the d-axis and q-axis. In FIG. 4, an α axis corresponding to the A-phase windings 805Aa and 805Ac and a β axis corresponding to the B-phase windings 805Ab and 805Ad are defined in the stationary coordinate system. Further, in FIG. 4, the d axis is defined along the direction of the magnetic flux created by the magnetic poles of the permanent magnet used in the rotor 805B, and the q axis is defined along the direction 90 degrees counterclockwise from the d axis (direction perpendicular to the d axis). The angle between the α axis and the d axis is defined as θ, and the rotation phase of the rotor 805B is represented by the angle θ. In the vector control, a rotating coordinate system based on the rotation phase θ of the rotor 805B is used. Specifically, vector control uses the q-axis component (torque current component) that generates torque in the rotor 805B and the d-axis component (excitation current component) that affects the strength of the magnetic flux that penetrates windings 805Aa to 805Ad. The torque current component is a current component in a rotating coordinate system of a current vector corresponding to the drive current flowing through windings 805Aa to 805Ad.

In other words, vector control is a control method for controlling a motor by performing phase feedback control, which controls the values of the torque current component and the excitation current component such that the deviation between the command phase representing the target phase of the rotor and the actual rotation phase is reduced. There is also a method of controlling the motor by performing speed feedback control, which controls the values of the torque current component and the excitation current component such that the deviation between the command speed representing the target speed of the rotor and the actual rotation speed is reduced.

### Functional Configuration of Motor Control Device

Next, the functional configuration of the motor control device 155 serving as a drive control unit that controls the separation motor 805 will be described with reference to FIG. 5. The motor control device 155 is configured with at least one ASIC and executes the functions described below.

As shown in FIG. 5, the motor control device 155 roughly includes, as circuits for performing vector control, a phase controller 502, a current controller 504, a coordinate inverse converter 505, a coordinate converter 511, a PWM inverter 506 that supplies drive current to the motor windings, and the like. The coordinate converter 511 converts the current vector corresponding to the drive current flowing through the A-phase and B-phase windings of the separation motor 805 from a stationary coordinate system represented by the α-axis and β-axis to a rotating coordinate system represented by the q-axis and d-axis. As a result, the drive current flowing through the winding is represented by the current value of the q-axis component, which is the current value in the rotating coordinate system as the torque current command value, and the current value of the d-axis component, which is the current value in the rotating coordinate system as the excitation current command value. Further, the current value of the q-axis component (hereinafter referred to as the “q-axis current value Iq”) corresponds to the value of the torque current that generates torque in the rotor 805B of the separation motor 805. Furthermore, the current value of the d-axis component (hereinafter referred to as the “d-axis current value Id”) corresponds to the value of the excitation current that affects the strength of the magnetic flux penetrating the windings of the separation motor 805, and does not contribute to the generation of torque in the rotor 805B.

The motor control device 155 can independently control the q-axis current and the d-axis current as the control currents to be applied to the separation motor 805. As a result, the motor control device 155 can efficiently generate the torque required to rotate the rotor 805B by controlling the q-axis current value Iq in accordance with the load torque applied to the rotor 805B. That is, in vector control, the magnitude of the current vector (that is, the q-axis current value Iq) shown in FIG. 4 changes according to the load torque applied to the rotor 805B. In other words, in vector control, the magnitude of the q-axis current value Iq can also be said to be the magnitude of the conveyance torque output by the separation motor 805. In other words, the load torque and the conveyance torque are torques generated by the separation motor 805, and the q-axis current value Iq is a value corresponding to the torque generated by this separation motor 805.

The motor control device 155 determines the rotation phase θ of the rotor 805B of the separation motor 805 by a method to be described later, and performs vector control based on the result of the determination. The CPU (A) 801 generates, as a command value, a command phase θ_ref that indicates a target phase of the rotor 805B of the separation motor 805, and outputs the command phase θ_ref to the motor control device 155. The command phase θ_ref is set based on the target speed of the rotor 805B of the separation motor 805, which corresponds to the target peripheral speed of the upper separation roller 2.

A subtractor 501 calculates and outputs the deviation Δθ between the rotational phase θ of the rotor 805B of the separation motor 805, output from the phase determiner 513, and the command phase θ_ref.

The phase controller 502 acquires the deviation Δθ at a period P (for example, 200 ms). The phase controller 502 generates and outputs a q-axis current command value Iq_ref and a d-axis current command value Id_ref based on proportional control (P), integral control (I), and differential control (D) such that the deviation Δθ obtained from the subtractor 501 becomes small. Specifically, the phase controller 502 generates and outputs the q-axis current command value Iq_ref and the d-axis current command value Id_ref based on the P control, I control, and D control such that the deviation Δθ obtained from the subtractor 501 becomes zero. P control is a control method in which the value of an object to be controlled is controlled based on a value proportional to the deviation between a command value and an estimated value. Furthermore, I control is a control method in which the value of an object to be controlled is controlled based on a value proportional to the time integral of the deviation between a command value and an estimated value. D control is a control method in which the value of an object to be controlled is controlled based on a value proportional to the change over time in the deviation between a command value and an estimated value. Although the phase controller 502 in this embodiment generates the q-axis current command value Iq_ref and the d-axis current command value Id_ref based on PID control, the present invention is not limited to this. For example, the phase controller 502 may generate the q-axis current command value Iq_ref and the d-axis current command value Id_ref based on PI control. In a case where a permanent magnet is used for the rotor 805B, the d-axis current command value Id_ref, which affects the strength of the magnetic flux passing through the winding, is usually set to 0, but this is not limitative.

The drive currents flowing through the A-phase and B-phase windings 805Aa to 805Ad of the separation motor 805 are detected by current detectors 507 and 508, and then converted from analog values to digital values by an A/D converter 510. The cycle in which the current detectors 507 and 508 detect the current is, for example, equal to or shorter than the cycle P in which the phase controller 502 acquires the deviation Δθ (for example, 25 [ms]).

The current value of the drive current converted from an analog value to a digital value by the A/D converter 510 is expressed by the following equation using the phase θe of the current vector shown in FIG. 4 as the α-axis drive current Iα and the β-axis drive current Iβ in the stationary coordinate system. The phase θe of the current vector is defined as the angle between the α axis and the current vector. Furthermore, I indicates the magnitude of the current vector.

Iα=I×COSθe (1)

Iβ=I×SINθe (2)

These α-axis driving current Iα and β-axis driving current Iβ are input to a coordinate converter 511 and an induced voltage determiner 512.

The coordinate converter 511 converts the α-axis drive current Iα and β-axis drive current Iβ in the stationary coordinate system into the q-axis current value Iq and d-axis current value Id in the rotating coordinate system, using the following equations.

Id=COSθ×Iα+SINθ×Iβ (3)

Iq=-SINθ×Iα+COSθ×Iβ (4)

The coordinate converter 511 outputs the converted q-axis current value Iq to the subtractor 503A. Furthermore, the coordinate converter 511 outputs the converted d-axis current value Id to the subtractor 503B. Further, the q-axis current value Iq and the d-axis current value Id output by the coordinate converter 511 can be read out by the CPU (A) 801. The q-axis current value Iq is the q-axis component (torque current component) and is proportional to the load torque applied to the rotor 805B. That is, by measuring the q-axis current value Iq, it is possible to measure the load torque applied to the separation motor 805 (upper separation roller 2) during feeding a document.

The subtractor 503A calculates the deviation between the q-axis current command value Iq_ref and the q-axis current value Iq, and outputs the deviation to the current controller 504. Furthermore, the subtractor 503B calculates the deviation between the d-axis current command value Id_ref and the d-axis current value Id, and outputs the deviation to the current controller 504.

The current controller 504 generates the q-axis drive voltage Vq and the d-axis drive voltage Vd based on PID control such that the input deviations are reduced. Specifically, the current controller 504 generates a q-axis drive voltage Vq and a d-axis drive voltage Vd such that the input deviations become zero, and outputs them to the coordinate inverse converter 505. In this embodiment, the current controller 504 generates the q-axis drive voltage Vq and the d-axis drive voltage Vd based on PID control, but the present invention is not limited to this. For example, the current controller 504 may generate the q-axis drive voltage Vq and the d-axis drive voltage Vd based on PI control.

The coordinate inverse converter 505 inversely converts the q-axis drive voltage Vq and the d-axis drive voltage Vd in the rotating coordinate system output from the current controller 504 into an α-axis drive voltage Vα and a β-axis drive voltage Vβ in the stationary coordinate system using the following equations.

Vα=COSθ×Vd−SINθ×Vq (5)

Vβ=SINθ×Vd+COSθ×Vq (6)

Then, the coordinate inverse converter 505 outputs the α-axis drive voltage Vα and the β-axis drive voltage Vβ in the inversely converted stationary coordinate system to the induced voltage determiner 512 and the PWM inverter 506.

The PWM inverter 506 has a full-bridge circuit. The full-bridge circuit is driven by a PWM signal based on the α-axis drive voltage Vα and the β-axis drive voltage Vβ input from the coordinate inverse converter 505. As a result, the PWM inverter 506 generates the α-axis drive current Iα and the β-axis drive current Iβ according to the α-axis drive voltage Vα and the β-axis drive voltage Vβ. The separation motor 805 is driven by supplying the α-axis drive current Iα and the β-axis drive current Iβ to the windings 805Aa to 805Ad of phases of the separation motor 805. In this embodiment, the PWM inverter has a full-bridge circuit, but the PWM inverter may also be a half-bridge circuit or the like.

Next, a method for determining the rotation phase θ will be described. The rotation phase θ of the rotor 805B is determined using the values of the α-axis induced voltage Eα and β-axis induced voltage Eβ induced in the A-phase and B-phase windings 805Aa to 805Ad of the separation motor 805 by the rotation of the rotor 805B. The value of the induced voltage is determined (calculated) by the induced voltage determiner 512. Specifically, the α-axis induced voltage Eα and the β-axis induced voltage Eβ are determined from the α-axis drive current Iα and the β-axis drive current Iβ, and the α-axis drive voltage Vα and the β-axis drive voltage Vβ by the following equations. Further, the α-axis drive current Iα and the β-axis drive current Iβ are input from the A/D converter 510 to the induced voltage determiner 512, and the α-axis drive voltage Vα and the β-axis drive voltage Vβ are input from the coordinate inverse converter 505 to the induced voltage determiner 512.

Eα=Vα−R×Iα−L×dIα/dt (7)

Eβ=Vβ−R×Iβ−L×dIβ/dt (8)

Here, R is the winding resistance and L is the winding inductance. The values of the winding resistance R and the winding inductance L are specific to the separation motor 805 being used, and are stored in advance in the ROM (A) 802 or a memory (not shown) provided in the motor control device 155. The α-axis induced voltage Eα and the β-axis induced voltage Eβ determined by the induced voltage determiner 512 are output to a phase determiner 513.

The phase determiner 513 determines the rotational phase θ of the rotor 805B of the separation motor 805 based on the ratio between the α-axis induced voltage Eα and the β-axis induced voltage Eβ output from the induced voltage determiner 512, using the following equation:

θ=Tan\hat{ }−1(−Eβ/Eα) (9)

The rotation phase θ of the rotor 805B obtained in this way is input to the subtractor 501, the coordinate inverse converter 505, and the coordinate converter 511.

In this embodiment, the phase determiner 513 determines the rotation phase θ by performing the calculation based on Equation (9), but this is not limitative. For example, the phase determiner 513 may determine the rotation phase θ, by referring to a table stored in the ROM (A) 802 or the like, which shows the relationship with the rotation phase θ corresponding to the α-axis induced voltage Eα and the β-axis induced voltage Eβ.

As described above, the motor control device 155 in this embodiment performs vector control which controls the current value in the rotating coordinate system such that the deviation between the command phase θ_ref and the rotational phase θ is reduced by repeatedly performing the above-described control. By performing vector control, it is possible to prevent the motor from step-out state, and to prevent an increase in motor noise and power consumption due to excess torque.

### Reading Job Control

Next, the control of a reading job of the image reading apparatus 105 according to this embodiment will be described with reference to FIG. 6. FIG. 6 is a flowchart showing the control of a reading job.

For example, when a user operates the operation display unit 904 to instruct scanning or copying of the document S, the CPU (B) 901 issues a command to the CPU (A) 801 via the command communication unit 421, and the CPU (A) 801 starts controlling the reading job shown in FIG. 6. Then, first, the CPU (A) 801 executes document feeding control (S1). The document feeding control will be described in detail later.

Next, the CPU (A) 801 determines whether or not the feeding has been completed normally (S2). In a case where it is determined that the feeding has been completed normally (Yes in S2), document reading control is executed (S3). That is, the optical scanner unit 202 is moved to the center position of the front glass facing member 211 of the ADF 300, and the image on the front side of the document S being conveyed is optically read by the optical scanner unit 202. Furthermore, thew optical scanner unit 302 optically reads the image on the back side of the document S being conveyed. The read image data is processed by the image processing unit (A) 811, transferred to the image processing unit (B) 905 of the image processing controller 400 via the image communication unit 422, and stored in the image memory 906.

Next, the CPU (A) 801 determines whether or not there is a document S to be fed next on the document tray 30 based on the detection result of the document presence/absence detection sensor 11 (S4). In a case where the next document S exists (Yes in S4), the process returns to step S1 and the feeding of the next document S is executed. In a case where the next document S does not exist (No in S4), conveyance system motors (separation motor 805, pull-out motor 806, lead motor 807, etc.) are stopped (S5), and control of the reading job is ended.

Furthermore, in a case where the CPU (A) 801 determines in step S2 that feeding has not been completed normally (No in S2), it stops each conveyance system motor (S5), stops the execution of control of the reading job, and ends control of the reading job.

### Feeding Control According to First Embodiment

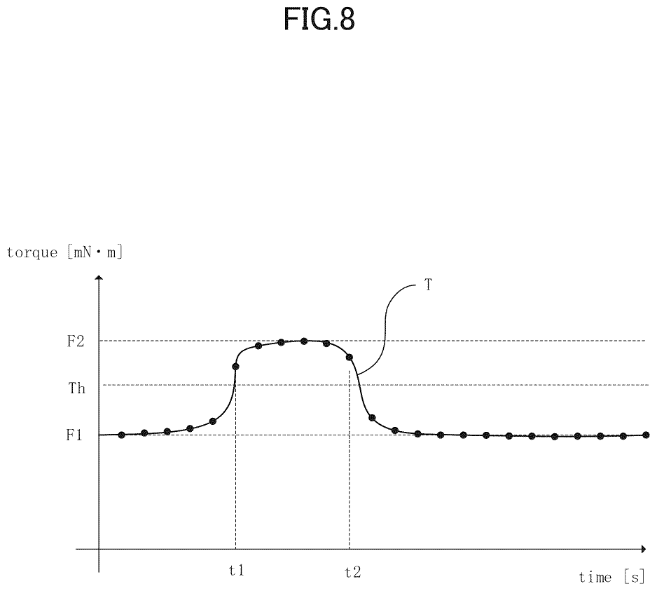

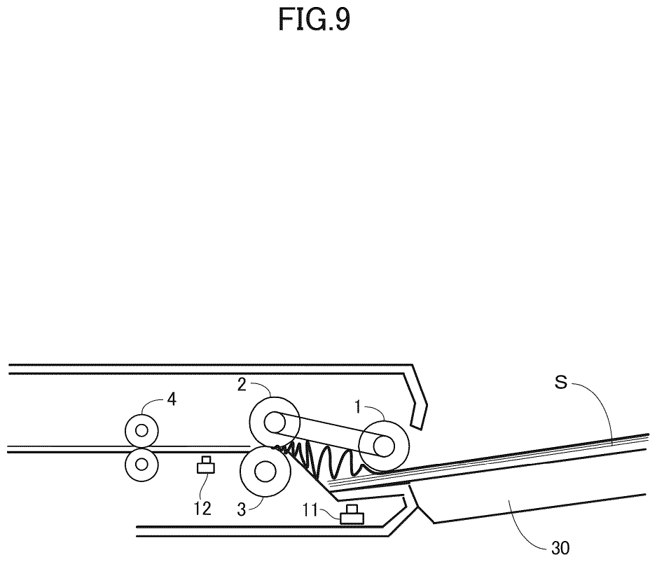

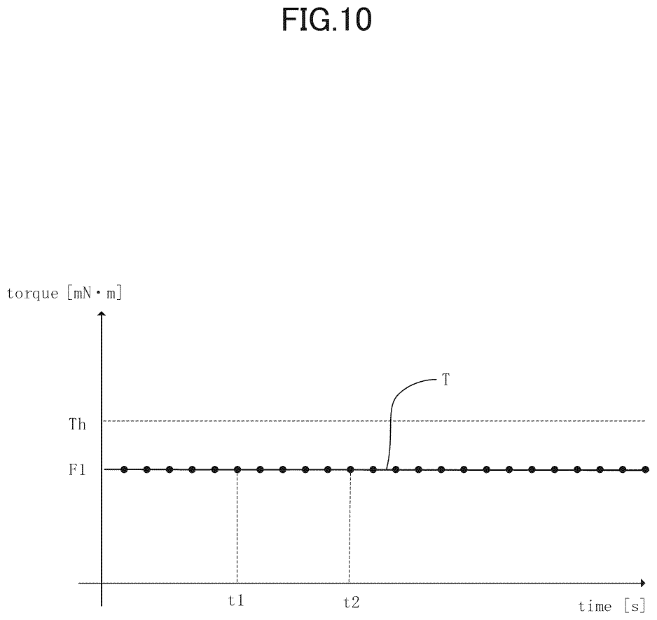

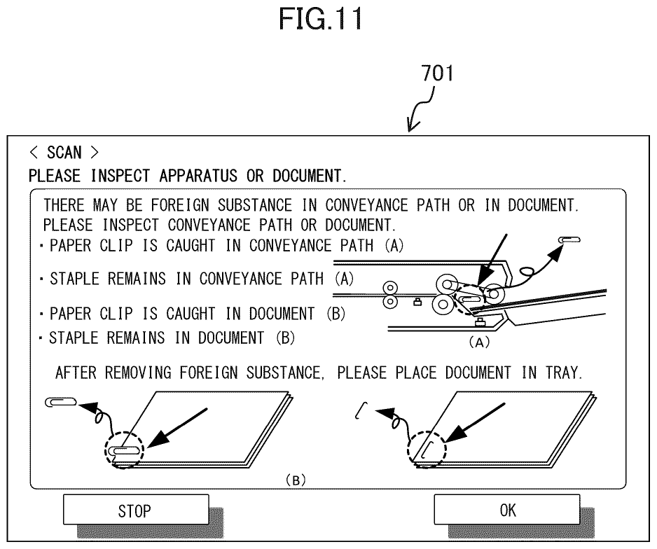

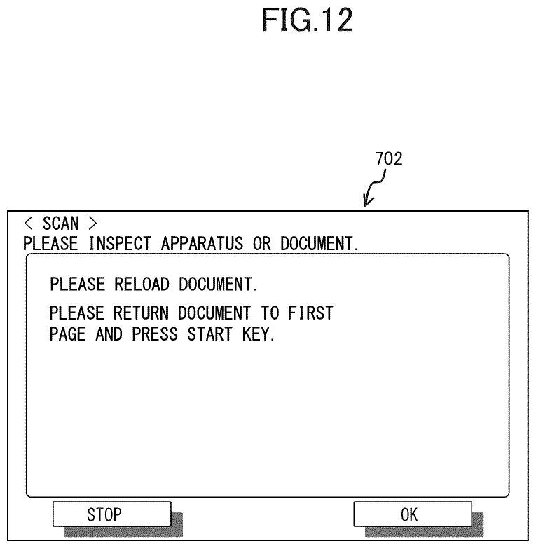

Next, feeding control of the ADF 300 according to the first embodiment will be described with reference to FIGS. 7 to 12. FIG. 7 is a flowchart showing the feeding control according to the first embodiment. FIG. 8 is a diagram showing the conveyance torque measured during feeding a document in a case where the document cannot be advanced due to a foreign substance. FIG. 9 is an enlarged cross-sectional view showing an ADF in a case where a document cannot be advanced due to a foreign substance. FIG. 10 is a diagram showing the conveyance torque measured in a case where the document has not been fed. FIG. 11 is a diagram showing an example of the foreign substance inspection screen. FIG. 12 is a diagram showing an example of the document inspection screen.

As shown in FIG. 7, when the CPU (A) 801 starts the feeding control, it first sets the number of feeding retries to 0 (S11). The number of feeding retries is a variable stored in the RAM (A) 803, and is initially set to 0 when feeding starts.

Next, the CPU (A) 801 starts driving each conveyance system motor, that is, starts feeding the document S (S12). In this embodiment, the conveyance system motors are three types: a separation motor 805, a pull-out motor 806, and a lead motor 807. By driving these motors, rollers drivingly connected to the respective motors are rotated, and the document S can be fed. Specifically, the CPU (A) 801 controls the separation motor 805 via the motor control device 155, controls the pull-out motor 806 via the motor control device 156, and controls the lead motor 807 via the motor control device 157. Of these, the separation motor 805 is a motor that separates and feeds one sheet of the topmost document S from a plurality of documents S (a stack of documents) stacked on the document tray 30. The CPU (A) 801 feedback-controls the separation motor 805 by using the motor control device 155 through the above-mentioned vector control.

Next, the CPU (A) 801 starts counting the time of a separation sensor jam timer for detecting a timeout (S13). That is, the separation sensor jam timer detects that the separation sensor 12 is not turned ON even after a set time has elapsed since the start of feeding (start of driving of the conveyance system motors). In a case where the set condition is considered to be met when the set time has elapsed and the separation sensor 12 is not turned ON, it can be determined that an abnormality (i.e., a jam or feeding failure) has occurred that delays the feeding of the document. This set time can be set by adding a margin time to the nominal value calculated from the distance of the conveyance path from the feed start position of the leading edge of the document S to the separation sensor 12, the feed speed of the separation motor 805, and the acceleration time.

Further, in a case where the amount of advance per pulse of the stepping motor can be measured, it is possible to use a different unit instead of measuring time using a timer. For example, the distance that the document S is to move can be obtained from the advance amount per pulse of the separation motor 805 and the gear ratio of a gear mechanism (not shown) that transmits the rotation of the separation motor 805 to the upper separation roller 2. In this case, there is no need to take the acceleration time into account. In other words, in a case where the separation sensor 12 is not turned ON when the separation motor 805 is driven for a distance equal to the sum of the distance of the conveyance path from the feeding start position to the separation sensor 12 and the margin distance, it can be determined that an abnormality has occurred that delays the feeding of the document. In other words, the set condition may be determined to be met when the rotation amount of the separation motor 805 reaches a set rotation amount that is the sum of the distance at which the leading edge of the document S reaches the separation sensor 12 in a case where the document S is fed normally and the margin distance.

Here, there are two possible causes for the abnormal delay in feeding the document: in a case where a foreign substance prevents the document S from being fed, causing the document S to jam, and in a case where there is insufficient force to feed the document S due to wear on the feed roller 1 or the document S sticking to the feed roller 1. In this embodiment, as will be described below, these two causes are distinguished and control is performed to execute processing according to the distinguished cause.

When the separation sensor jam timer starts counting in step S13, the CPU (A) 801 starts measuring the conveyance torque T generated in the separation motor 805 (S14). The conveyance torque T of the separation motor 805 can be obtained from the motor control device 155 that performs vector control as described above, and controls the separation motor 805. Specifically, the q-axis current value Iq output from the coordinate converter 511 shown in FIG. 5 is a value corresponding to the conveyance torque T, that is, the conveyance torque is a value proportional to the q-axis current value Iq.

Specifically, the equation for converting the acquired q-axis current value Iq into the conveyance torque T can be expressed by the following equation.

T=G*Iq+O (10)

The values of the inclination G and the offset O can be stored in advance in the ROM (A) 802 according to the characteristics of the separation motor 805.

The measurement section of the conveyance torque T by the CPU (A) 801 is the section from the time at which the separation motor 805 completes acceleration to the time at which the separation sensor jam timer set in step S13 finishes measuring the set time. This makes it possible to avoid the influence of torque fluctuations when the separation motor 805 is accelerating, and even in a case where the document S is jammed, to measure the change in the conveyance torque T when the jam occurs. In a case where the separation sensor 12 is normally turned ON, the measurement of the conveyance torque T may be ended. Furthermore, the conveyance torque T may be measured from the start of driving the separation motor 805.

As a data transfer function of assisting the CPU (A) 801, a Direct Memory Access (DMA) or Data Transfer Control (DTC) built into the CPU (A) 801 may be used. Using DMA or DTC, it is possible to sample the q-axis current value Iq (or the converted conveyance torque T) into the RAM (A) 803 at predetermined time intervals, making it possible to acquire data in parallel with other calculation processes.

Next, the CPU (A) 801 determines whether the separation sensor 12 is turned ON (S15). In a case where the separation sensor 12 is turned ON (Yes in S15), feeding has been completed normally, so this control is ended and the process proceeds to step S2 in FIG. 6 described above.

On the other hand, in a case where the separation sensor 12 is not turned ON (No in S15), it is determined whether the separation sensor jam timer has elapsed the set time (S16). In a case where the separation sensor jam timer has not yet elapsed the set time (No in S16), the process returns to step S15, and it is determined again whether the separation sensor 12 is ON.

Here, in a case where the separation sensor jam timer has elapsed the set time (Yes in S16), it is determined that the set condition has been met; in other words, since the separation sensor 12 is not turned ON (No in S15), it is determined that the feeding of the document S is defective. In a case where the document S is not properly fed in this way, the CPU (A) 801 first stops each conveyance system motor (S17).

In this embodiment, the control in which the documents S are conveyed one by one and the next document S is fed after the image on the document S has been read has been described with reference to FIG. 6. However, in order to increase the productivity of reading a plurality of documents, it is common to perform feeding control and reading control in parallel. In such a case, the motors stopped in step S17 may be limited to only the separation motor 805. In other words, in a case where the next document S is fed while the image of the document S located downstream of the upper separation roller 2 in the conveyance path of the document S is read, the pull-out motor 806 and the lead motor 807 may continue to be driven without stopping.

Next, the CPU (A) 801 determines whether or not the measured conveyance torque T has become larger than a preset threshold value Th while the separation sensor jam timer counts the set time (S18). That is, in a case where the measured conveyance torque T is equal to or less than the threshold value Th (No in S18), the CPU (A) 801 first increments the number of feeding retries (i.e., the counter) by +1 (S20). The number of feeding retries is a variable that is set to 0 in step S11 and stored in the RAM (A) 803, and by increasing the number of feeding retries by one in step S20, the number of retries of feeding the document S is counted by one.

Here, the conveyance torque data in a case where the conveyance torque T is equal to or less than the threshold value Th will be described with reference to FIG. 10. The data shown in FIG. 10 is measurement data of the conveyance torque T from the time when the separation motor 805 completes acceleration until the set time set by the separation sensor jam timer set in S13 has elapsed. As a case in which data is obtained in which the conveyance torque T does not become large, a case is considered in which the static friction between the topmost document S among the documents S stacked on the document tray 30 and the document S immediately below the topmost document S is large, that is, when the topmost document D is stuck. In other words, this is the case where the feed roller 1 cannot feed the topmost document S and rotates idly. Although the separation motor 805 is rotating, it is not affected by the conveyance load of the document S, and therefore the conveyance torque T does not increase. Therefore, in step S18, it is determined that the measured conveyance torque T is equal to or less than the threshold value Th. In the above-described embodiment, it is determined in step S18 whether the conveyance torque T is greater than the threshold value Th or equal to or less than the threshold value Th. However, for example, it may be determined whether the conveyance torque T is equal to or greater than the threshold value Th or whether the conveyance torque T is smaller than the threshold value Th. In other words, in a case where the conveyance torque T is the same as the threshold value Th, the answer to step S18 may be Yes or No; at least in a case where the conveyance torque T is greater than the threshold value Th, the answer to step S18 may be Yes, and in a case where the conveyance torque T is less than the threshold value Th, the answer to step S18 may be No.

Next, the CPU (A) 801 determines whether the number of feeding retries is equal to or greater than a set number of times that is set in advance (S21). In this embodiment, the set number of times is, for example, three times. In other words, a re-feeding process may be repeated up to the set number of times. By performing the re-feeding process (i.e., retries) multiple times, the possibility that the feed roller 1 is able to feed the topmost document S increases. However, in a case where the feeding (pick-up) performance is reduced due to wear of the feed roller 1 or the like, it is considered that the possibility of feeding the document S does not increase even if the number of re-feeding processes is excessively increased, so the set number of times is set as the upper limit number.

In a case where the number of feeding retries is equal to or greater than the set number of times (Yes in S21), the CPU (A) 801 sends a command to the CPU (B) 901 via the command communication unit 421 to display a jam processing screen. Then, upon receiving the command, the CPU (B) 901 displays, on the operation display unit 904, a jam screen of a document inspection screen 702 as information on a notification prompting inspection as shown in FIG. 12 (S24). That is, the CPU (B) 901 outputs and displays the document inspection screen 702 indicating that a jam has occurred in which the document S could not be fed on the operation display unit 904 to the user. In other words, in this case, when the conveyance torque T does not become larger than the threshold value Th, a jam of the document S is detected, so there is a possibility that there is a problem with the way the document S is set, or that the document S is jammed. Therefore, the document inspection screen 702 as shown in FIG. 12 is displayed to prompt the user to remove the jammed document S and set it again together with the documents S remaining on the document tray 30. Then, the above-described feeding control is ended as an abnormality has occurred. After that, it is determined in step S2 shown in FIG. 6 that feeding has not ended normally, and the reading job is ended.

On the other hand, in a case where the number of feeding retries is less than the set number of times (No in S21), the CPU (A) 801 rotates the separation motor 805 in the reverse direction serving as a second rotation direction, which is opposite to the first rotation direction for feeding the document S, for a certain period of time (S22). The certain period of time is, for example, a period of time during which the distance from the leading edge position Sa of the document S at the document set position shown in FIG. 2 to the separation sensor 12 is the distance that the upper separation roller 2 and the feed roller 1 move in the reverse direction depending on the rotation speed of the separation motor 805 when rotating in the reverse direction. By performing the operation of returning the documents S in this way, it is aimed to change the position where the feed roller 1 comes into contact with the topmost document S at the next feeding time, and the relative positional relationship between the topmost document S among the plurality of documents S and the document S immediately below the topmost document S (the second one from the top). That is, the upper separation roller 2 and the feed roller 1 are rotated in the reverse direction in order to increase the possibility of feeding the topmost document S when the re-feeding process is executed (when a retry is made).

Then, the CPU (A) 801 stops the separation motor 805 (S23), that is, stops the reverse rotation of the upper separation roller 2 and the feed roller 1. That is, in order to execute the feeding process again (retry operation), the separation motor 805 is stopped to prepare for the next feeding.

In this embodiment, the separation motor 805 is rotated in the reverse direction for a certain period of time in step S22, and the separation motor 805 that has been rotating in the reverse direction is stopped in step S23, but these steps can be omitted. That is, by doing so, the separation motor 805 is stopped in step S17, and the document is fed again from the state in which the feed roller 1 is stopped. This is because, when the document S and the feed roller 1 are in contact with each other, the static friction that occurs between them can be applied to the topmost document S, and there is a possibility that the topmost document S can be fed.

As described above, once the separation motor 805 is stopped and it is determined that a re-feeding process is to be performed (No in S21), the CPU (A) 801 returns to the process of step S12 and executes control to feed the document S again by starting to drive each conveyance system motor again. At this time, in the processes from steps S17 to S23, in a case where the separation motor 805 is the only motor that has stopped, there is no need to restart to drive the pull-out motor 806 or the lead motor 807. That is, the pull-out motor 806 and the lead motor 807 are maintained in a state in which they are already rotating, so that the feeding control of the document S can be resumed.

Next, a description will be given of the case where the measured conveyance torque T is greater than the threshold value Th in step S18 (Yes in S18). In step S18, the set time has elapsed as counted by the separation sensor jam timer, and the data of the conveyance torque T up to that point is stored in the RAM (A) 803. The maximum value of the data of the conveyance torque T that has been stored is calculated, and it is determined whether or not the maximum value exceeds a preset threshold value Th. With respect to the threshold value Th, the conveyance torque T during normal conveyance and the conveyance torque T in a case where a foreign substance is present on the conveyance path which is the feeding path are measured, and the average value is stored in the ROM (A) 802. However, the threshold value Th is not limited to such an average value, and may be any value that can distinguish between a state in which the document S is normally conveyed and a state in which the document S is not moving forward due to a foreign substance.

Here, a case where a foreign substance prevents the feeding of the document S and the load torque of the separation motor 805 increases will be described. As shown in FIG. 9, in a case where a foreign substance such as a paper clip or a sticky note is caught near the upper separation roller 2 or the lower separation roller 3, the document S is not able to move downstream in the feeding direction from the upper separation roller 2 or the lower separation roller 3. As a result, data of the conveyance torque T as shown in FIG. 8 is measured. The data of the measured conveyance torque T is stored in the CPU (A) 801 as described above.

The example shown in FIG. 8 is an example in which a measurement of the conveyance torque T converted based on the q-axis current value Iq is obtained at 24 points in 5 ms intervals. For example, at time t1, when the document S stops moving, the load torque acting on the upper separation roller 2 and the lower separation roller 3 from the document S increases, and the conveyance torque T fluctuates to increase. Then, for example, at time t2, the document S slips on the upper separation roller 2 and the lower separation roller 3, the load torque received by acting on the upper separation roller 2 and the lower separation roller 3 from the document S decreases, and the conveyance torque T fluctuates to decrease.

In a case where the CPU (A) 801 detects that the conveyance torque T measured in this manner has become greater than the threshold value Th (Yes in S18), the process does not proceed to the re-feeding process (retry control) as described above. Then, the CPU (A) 801 transmits a command to the CPU (B) 901 via the command communication unit 421 in order to display a jam processing screen. Then, upon receiving the command, the CPU (B) 901 displays, on the operation display unit 904, a jam screen of the foreign substance inspection screen 701 serving as information on a notification prompting inspection as shown in FIG. 11 (S19). That is, the CPU (B) 901 outputs and displays the foreign substance inspection screen 701 indicating that a jam has occurred in which the document S could not be fed due to a foreign substance entering the conveyance path on the operation display unit 904 to the user. That is, in this case, when the conveyance torque T becomes larger than the threshold value Th and it is determined that the document S is jammed, it is possible that a foreign substance such as a paper clip has entered the conveyance path, or that the document S is clipped or stapled in a bundle. Therefore, by displaying the foreign substance inspection screen 701 as shown in FIG. 11, the user is notified that there is a possibility that a foreign substance has entered the conveyance path, and an image is displayed to make it visually easy to understand. In addition, to enable the user to remove the foreign substances and then perform reading again, a message is also displayed saying, “Please remove the foreign substance and then place the document on the tray.” Therefore, the foreign substance inspection screen 701 is displayed to prompt the user to remove the foreign substance and then to re-read the document S. Then, the above-described feeding control is ended as an abnormality has occurred. After that, it is determined in step S2 shown in FIG. 6 that feeding has not ended normally, and the reading job is ended.

As described above, in the ADF 300 according to this embodiment, the CPU (A) 801 determines that the feeding of the document S by the separation motor 805 and the upper separation roller 2 is defective (No in S15). In this case, in a case where the conveyance torque T generated by the separation motor 805 when feeding the document S is greater than the threshold value Th (Yes in S18), the re-feeding process is not performed by the separation motor 805 and the upper separation roller 2, and the foreign substance inspection screen 701 is displayed. This makes it possible to notify the user to prompt inspection, and prevents the user from feeding the next document S without noticing it. Therefore, the possibility of the next document S jamming can be reduced, and the occurrence of document S jamming can be reduced.

In particular, in a case where the conveyance torque T generated by the separation motor 805 when the document S is fed is greater than the threshold value Th (Yes in S18), the foreign substance inspection screen 701 is displayed. This makes it possible to notify the user of the possibility that foreign substance has entered the conveyance path or that foreign substance has adhered to the document S (the document stack is fastened with a clip or the like), thereby preventing the user from feeding the next document S without noticing.

Furthermore, in a case where the conveyance torque T generated by the separation motor 805 when feeding the document S is smaller than the threshold value Th (No in S18), a re-feeding process (retry) of re-executing the feeding operation of the document S is performed. Then, after repeating this re-feeding process a set number of times, in a case where it is determined that the feeding of the document S is defective (Yes in S21), the document inspection screen 702 serving as information is displayed. Thus, the document inspection screen 702 is displayed in a case where there is a problem with the way the document S is set or the document S is jammed, and the user can be prompted to remove the jammed document S and set it again together with the documents S remaining in the document tray 30.

In addition, in this embodiment, in a case where it is determined that the feeding of the document S is defective and the conveyance torque T generated by the separation motor 805 during the feeding of the document S is greater than the threshold value Th (Yes in S18), the feeding control is ended as an abnormality. That is, for example, a document S fastened with a clip or a document S with a sticky note attached may not be properly cleared from the jam in the conveyance path, or a foreign substance such as a clip or sticky note may remain on the conveyance path. When re-feeding is performed in such a case, there is a risk that the document S may be damaged, and there is also a risk that the document S may be caught in the upper separation roller 2 or the like due to re-feeding. However, by performing feeding control as in this embodiment, it is possible to prevent re-feeding in such cases, and to reduce damage to the document S caused by re-feeding the document S.

Furthermore, in the ADF 300 according to this embodiment, in a case where the CPU (A) 801 determines that a re-feeding process is to be performed, it rotates the separation motor 805 in the reverse direction to execute a process of returning the document S, thereby increasing the possibility of feeding the document S in the re-feeding process. However, in a case where the document S is jammed due to a foreign substance or the like, there is a possibility that the document S may be damaged even in a case where the separation motor 805 is rotated in the reverse direction. However, in this embodiment, the CPU (A) 801 determines that the document S is jammed due to a foreign substance or the like based on the conveyance torque T, and is therefore able to prevent the separation motor 805 from rotating in the reverse direction, thereby reducing damage to the document S.

In this embodiment, the CPU (A) 801 determines that the document S is not properly fed (jammed) in a case where it determines that the set time has elapsed using the separation sensor jam timer. However, this is not limiting, and it is also possible to detect that the conveyance torque T has become greater than the threshold value Th, thereby determining that some abnormality has occurred in the conveyance path, and determining that the document S is not being fed properly (jammed). In this configuration, the feeding of the document S can be stopped at the timing when the conveyance torque T exceeds the threshold value Th at time t1 shown in FIG. 8. This makes it possible to be expected to further reduce damage to the document S. In this case, since the conveyance torque T is already greater than the threshold value Th, it is determined in step S18 that the re-feeding process (retry) is not to be performed.

### Second Embodiment

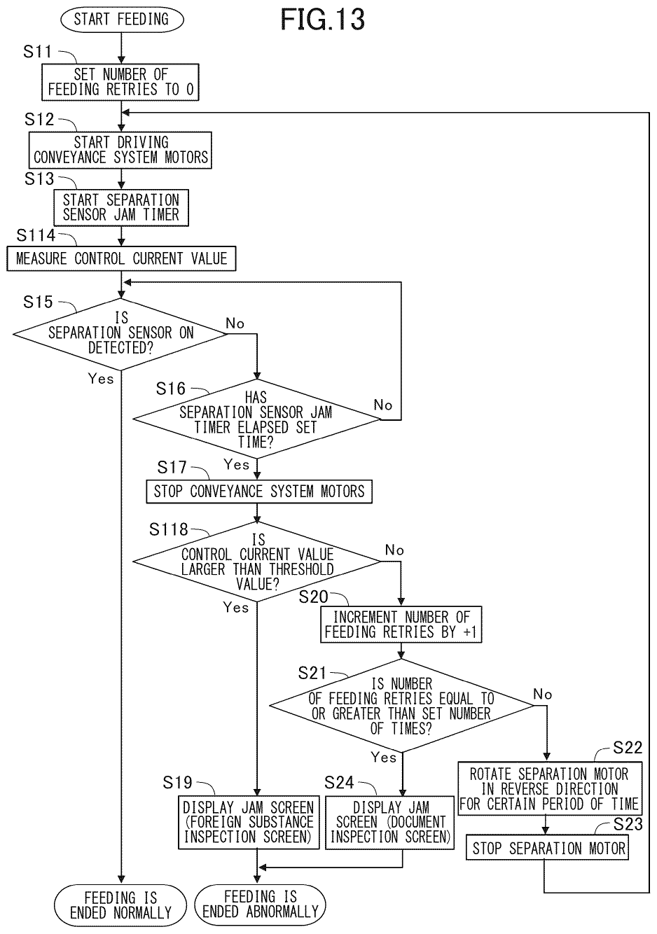

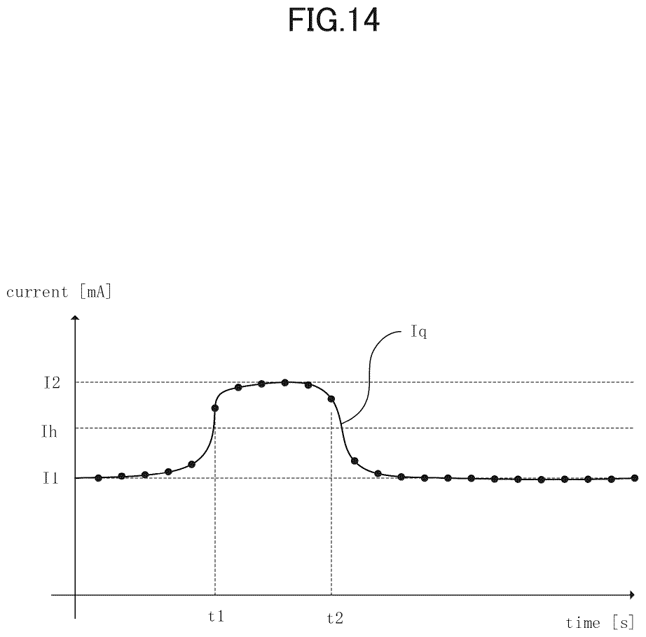

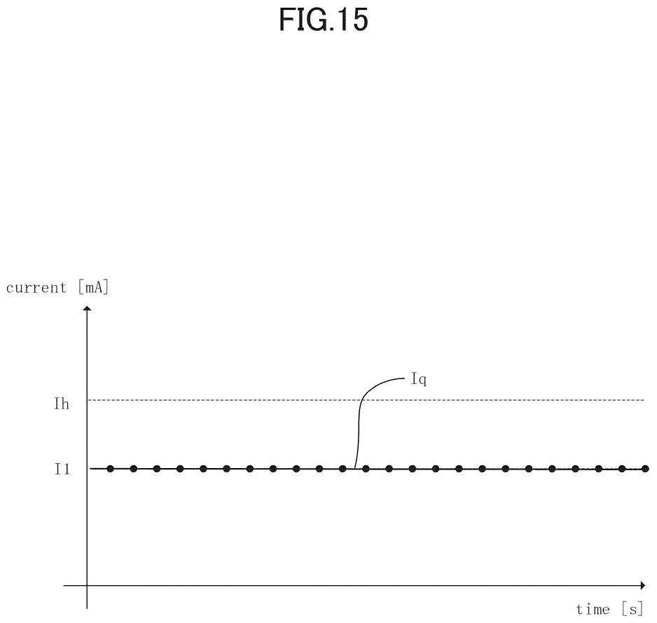

Next, a second embodiment, which is a partial modification of the first embodiment, will be described with reference to FIGS. 13 to 15. FIG. 13 is a flowchart showing the feeding control according to the second embodiment. FIG. 14 is a diagram showing the current value of the torque current component measured when feeding a document in a case where the document cannot be advanced due to a foreign substance. FIG. 15 is a diagram showing a current value of a torque current component measured in a case where a document has not been fed.

In the first embodiment, whether or not to perform the re-feeding process is determined depending on the value of the conveyance torque T from the start of time counting by the separation sensor jam timer until the set time has elapsed. In contrast to this, in the second embodiment, whether or not to perform the re-feeding process is determined not according to the conveyance torque T but according to the q-axis current value Iq (that is, the control current value of the separation motor 805). The control in the second embodiment will be described below. Further, the feeding control in the second embodiment shown in FIG. 13 differs from the feeding control shown in FIG. 7 in steps S114 and S118, but other parts are the same as those in the first embodiment, so the explanation thereof will be simplified or omitted.

As shown in FIG. 13, when the CPU (A) 801 starts counting the time of the separation sensor jam timer in step S13, the CPU (A) 801 starts measuring the q-axis current value Iq (S114). The q-axis current value Iq can be obtained from the motor control device 155 that performs vector control as described above and controls the separation motor 805.

The measurement section of the q-axis current value Iq by the CPU (A) 801 is the section from the time at which the separation motor 805 completes acceleration to the time at which the separation sensor jam timer set in step S13 finishes measuring the set time. This makes it possible to avoid the influence of torque fluctuations when the separation motor 805 is accelerating, and even in a case where the document S is jammed, to measure the change in the q-axis current value Iq when the jam occurs. In a case where the separation sensor 12 is normally turned ON, the measurement of the q-axis current value Iq may be ended. Furthermore, the q-axis current value Iq may be measured from the start of driving the separation motor 805.

As a data transfer function of assisting the CPU (A) 801, a Direct Memory Access (DMA) or Data Transfer Control (DTC) built into the CPU (A) 801 may be used. The DMA or DTC makes it possible to sample the q-axis current value Iq into the RAM (A) 803 at predetermined time intervals, making it possible to acquire data in parallel with other calculation processes.

Then, when the separation sensor 12 is not turned ON (No in S15) and the counting of the separation sensor jam timer has elapsed the set time (Yes in S16), each conveyance system motor is stopped (S17), and it is determined whether the q-axis current value Iq is greater than the threshold value Ih (S118). That is, in a case where the measured q-axis current value Iq is equal to or less than the threshold value Ih (No in S118), the CPU (A) 801 proceeds to step S20 to perform a re-feeding process (retry).

Here, the q-axis current value data in a case where the q-axis current value Iq is equal to or smaller than the threshold value Ih will be described with reference to FIG. 15. The data shown in FIG. 15 is the measurement data of the q-axis current value Iq from the time when the separation motor 805 completes acceleration until the set time set by the separation sensor jam timer set in S13 has elapsed. As a case in which data is obtained in which the q-axis current value Iq does not become large, a case is considered in which the topmost document D is stuck, as in the first embodiment. That is, although the feed roller 1 rotates idly and the separation motor 805 rotates, the q-axis current value Iq does not increase because it is not affected by the conveyance load of the document S. Therefore, in step S18, it is determined that the measured q-axis current value Iq is equal to or less than the threshold value Ih.

In a case where the q-axis current value Iq measured in this manner is equal to or less than the threshold value Ih (No in S118), the CPU (A) 801 increments the number of feeding retries (i.e., the counter) by +1 (S20) and determines whether the number of feeding retries is equal to or greater than a set number of times that is set in advance (S21). In a case where the number of feeding retries is equal to or greater than the set number of times (Yes in S21), a jam screen of the document inspection screen 702 is displayed (S24). That is, the CPU (B) 901 displays the document inspection screen 702 indicating that a jam has occurred in which the document S could not be fed on the operation display unit 904 to the user. In other words, in this case, when the conveyance torque T does not become larger than the threshold value Th, a jam of the document S is determined, so there is a possibility that there is a problem with the way the document S is set, or that the document S is jammed. Therefore, the document inspection screen 702 as shown in FIG. 12 is displayed to prompt the user to remove the jammed document S and set it again together with the documents S remaining on the document tray 30. Then, the above-described feeding control is ended as an abnormality has occurred. After that, it is determined in step S2 shown in FIG. 6 that feeding has not ended normally, and the reading job is ended.

Furthermore, in a case where the number of feeding retries is less than the set number of times (No in S21), the CPU (A) 801 rotates the separation motor 805 in the reverse direction, which is opposite to the rotation direction for feeding the document S, for a certain period of time (S22). That is, the upper separation roller 2 and the feed roller 1 are rotated in the reverse direction in order to increase the possibility of feeding the topmost document S when the re-feeding process is executed (when a retry is made). Then, the CPU (A) 801 stops the separation motor 805 (S23), that is, stops the reverse rotation of the upper separation roller 2 and the feed roller 1. That is, in order to execute the feeding process again (retry operation), the separation motor 805 is stopped to prepare for the next feeding.

On the other hand, the case where the measured q-axis current value Iq is greater than the threshold value Ih in step S118 (Yes in S118) will be described. For example, when a foreign substance prevents the feeding of the document S and the load torque of the separation motor 805 increases, that is, a foreign substance is caught in the conveyance path, the document S is not able to move downstream in the feeding direction from the upper separation roller 2 and the lower separation roller 3. As a result, data of the conveyance torque T as shown in FIG. 14 is measured. The data of the measured conveyance torque T is stored in the CPU (A) 801 as described above.

As shown in FIG. 14, when the document S stops moving, for example, at time t1, the load torque acting on the upper separation roller 2 and the lower separation roller 3 from the document S increases, and the q-axis current value Iq fluctuates to increase. Then, for example, at time t2, the document S slips on the upper separation roller 2 and the lower separation roller 3, the load torque acting on the upper separation roller 2 and the lower separation roller 3 from the document S decreases, and the q-axis current value Iq fluctuates to decrease.

In a case where the CPU (A) 801 detects that the q-axis current value Iq measured in this manner is greater than the threshold value Ih (Yes in S18), the process does not proceed to the re-feeding process (retry control) as described above. Then, upon receiving the command, the CPU (B) 901 displays the jam screen of the foreign substance inspection screen 701 on the operation display unit 904 (S19). That is, the CPU (B) 901 displays the foreign substance inspection screen 701 indicating that a jam has occurred in which the document S could not be fed due to a foreign substance entering the conveyance path on the operation display unit 904 to the user. That is, by displaying the foreign substance inspection screen 701, the user is notified that there is a possibility that a foreign substance has entered the conveyance path, and an image is displayed to make it visually easy to understand. In addition, a message is also displayed to allow the user to remove the foreign substance and then perform reading again. Therefore, the foreign substance inspection screen 701 is displayed to prompt the user to remove the foreign substance and then to re-read the document S. Then, the above-described feeding control is ended as an abnormality has occurred. After that, it is determined in step S2 shown in FIG. 6 that feeding has not ended normally, and the reading job is ended.

As described above, in the ADF 300 according to the second embodiment, the CPU (A) 801 also determines that the feeding of the document S by the separation motor 805 and the upper separation roller 2 is defective (No in S15). In this case, if the conveyance torque T generated by the separation motor 805 during feeding the document S is greater than the threshold value Th (Yes in S18), the re-feeding process is not performed by the separation motor 805 and the upper separation roller 2, and the foreign substance inspection screen 701 is displayed. This makes it possible to notify the user to prompt inspection, and prevents the user from feeding the next document S without noticing it. Therefore, the possibility of the next document S jamming can be reduced, and the occurrence of document S jamming can be reduced.

The other configurations, actions, and effects of the second embodiment are the same as those of the first embodiment, and therefore description thereof will be omitted. In the above-described embodiment, in step S118, it is determined whether the q-axis current value Iq is greater than the threshold value Ih or the q-axis current value Iq is equal to or less than the threshold value Ih. However, for example, it may be determined whether the q-axis current value Iq is equal to or greater than the threshold value Ih, or whether the q-axis current value Iq is smaller than the threshold value Ih. In other words, when the q-axis current value Iq is the same as the threshold value Ih, the answer to step S118 may be Yes or No; at least in a case where the q-axis current value Iq is greater than the threshold value Ih, the answer to step S118 may be Yes, and in a case where the q-axis current value Iq is smaller than the threshold value Ih, the answer to step S118 may be No.

### Possibilities of Other Embodiments

In the above-described first and second embodiments, the ADF 300 that feeds documents has been described as an example of a sheet feeding apparatus, but the present invention is not limited to this. For example, any apparatus may be used as long as it is an apparatus that feeds sheets (documents) in an image forming apparatus such as a scanner device, a printer, or a multifunction device.

In addition, in the first and second embodiments, it is described that the feeding of the document (sheet) is determined to be defective based on the fact that the separation sensor 12 does not detect the document until the set time has elapsed from the start of feeding (the start of time counting of the separation sensor jam timer). However, the present invention is not limited to this, and any type of sensor may be used for the detection, and further, any method may be used as long as it can detect a feeding failure.

Furthermore, in the first and second embodiments, as the torque generated by the separation motor 805 serving as a driving unit, a conveyance torque is described as an example, but it may be a load torque. Furthermore, the conveyance torque and the load torque have been described as being calculated based on the control current of the motor control device 155, but they are not limited to this and may be values measured by a torque measuring instrument, torque sensor, or the like.

Furthermore, in the first and second embodiments, the separation motor 805 is described as a stepping motor, but the present invention is not limited to this, and any motor, such as an AC motor or a DC motor, may be used.

In the first and second embodiments, the operation display unit 904 capable of displaying a screen is described as an output unit that outputs the foreign substance inspection screen 701 shown in FIG. 11 and the document inspection screen 702 shown in FIG. 12 as information. However, for example, the foreign substance inspection screen 701 and the document inspection screen 702 serving as information may be output to a monitor connected to an external computer or the like via an interface connected to an external network by wire or wireless communication. In this case, the interface corresponds to an output unit that outputs information.

In the first and second embodiments, the sheet re-feeding process (retry) is performed in a case where the conveyance torque or the control current value is not greater than the threshold value. However, the present invention is not limited to this, and the sheet re-feeding process may not be performed.

The present disclosure can also be implemented by supplying a program that implements one or more functions of the above-described embodiments to a system or apparatus via a network or storage medium, and reading and executing the program by one or more processors in the computer of the system or apparatus. It can also be implemented by a circuit (for example, an ASIC) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-038774 filed Mar. 11, 2025, which is hereby incorporated by reference herein in its entirety.

What is claimed is:

1. A sheet feeding apparatus comprising:
a sheet support unit configured to support a sheet;
a sheet feeding unit including a rotary feeding member configured to feed the sheet supported by the sheet support unit, and a driving unit configured to drive the rotary feeding member;
a control unit configured to control the driving unit; and
an output unit configured to output information,
wherein in a case where it is determined that feeding of the sheet by the sheet feeding unit is defective and a value corresponding to a torque generated in the driving unit during feeding of the sheet is greater than a threshold value, the control unit is configured to output information on a notification prompting inspection, by the output unit.

2. The sheet feeding apparatus according to claim 1,
wherein the output unit is a display unit capable of displaying information, and
wherein in the case where it is determined that feeding of the sheet by the sheet feeding unit is defective and the value corresponding to the torque generated in the driving unit during feeding of the sheet is greater than the threshold value, the control unit is configured to display the information on the notification prompting inspection, by the display unit.

3. The sheet feeding apparatus according to claim 1,
wherein the inspection includes an inspection for foreign substance that enters a feeding path through which sheets are fed by the sheet feeding unit.

4. The sheet feeding apparatus according to claim 1,
wherein the inspection includes an inspection for a sheet that enters a feeding path through which sheets are fed by the sheet feeding unit, or a foreign substance that adheres to the sheet.

5. The sheet feeding apparatus according to claim 1, further comprising:
a drive control unit configured to control the driving unit, by calculating a torque current command value and an excitation current command value based on a command value input from the control unit, and generating a control current to be applied to the driving unit,
wherein the control unit is configured to acquire a value of a torque current component based on the control current applied from the drive control unit to the driving unit, as the value corresponding to the torque generated in the driving unit.

6. The sheet feeding apparatus according to claim 5,
wherein the driving unit is a stepping motor.

7. The sheet feeding apparatus according to claim 1, further comprising:
a sheet detection unit configured to detect the sheet fed by the sheet feeding unit downstream of the sheet feeding unit in a feeding direction,
wherein the control unit is configured to determine that feeding of the sheet by the sheet feeding unit is defective based on a detection result of the sheet detection unit.

8. The sheet feeding apparatus according to claim 1,
wherein the control unit is configured to determine that feeding of the sheet by the sheet feeding unit is defective in a case where the value corresponding to the torque generated by the driving unit during feeding of the sheet becomes larger than the threshold value.

9. The sheet feeding apparatus according to claim 1,
wherein in a case where it is determined that feeding of the sheet by the sheet feeding unit is defective, the control unit is configured to:
stop a feeding operation of the sheet by the sheet feeding unit, and
when the value corresponding to the torque generated in the driving unit during feeding of the sheet is smaller than the threshold value, perform a re-feeding process in which the sheet feeding unit re-executes the feeding operation.

10. The sheet feeding apparatus according to claim 1,
wherein in a case where it is determined that feeding of the sheet by the sheet feeding unit is defective, the control unit is configured to:
stop a feeding operation of the sheet by the sheet feeding unit, and
when the value corresponding to a torque generated in the driving unit during feeding of the sheet is smaller than the threshold value, does not output, by the output unit, information on a notification prompting inspection.

11. The sheet feeding apparatus according to claim 1,
wherein in a case where it is determined that feeding of the sheet by the sheet feeding unit is defective, and the value corresponding to the torque generated in the driving unit during feeding of the sheet is greater than the threshold value, the control unit is configured to output information related to a notification that prompts an inspection for a foreign substance that enters a feeding path through which sheets are fed by the sheet feeding unit, by the output unit, and
wherein in a case where it is determined that feeding of the sheet by the sheet feeding unit is defective and the value corresponding to the torque generated in the driving unit during feeding of the sheet is smaller than the threshold value, the control unit is configured not to output the information by the output unit.

12. The sheet feeding apparatus according to claim 9,
wherein in the re-feeding process, the control unit is configured to drive the driving unit in a second rotation direction opposite to a first rotation direction for feeding the sheet in the sheet feeding direction before re-executing the feeding operation.

13. The sheet feeding apparatus according to claim 9,
wherein the control unit is configured to be able to repeatedly execute the re-feeding process up to a set number of times.

14. The sheet feeding apparatus according to claim 13,
wherein in a case where it is determined that feeding of the sheet by the sheet feeding unit is defective after repeating the re-feeding process a set number of times, the control unit is configured to output information on a notification prompting an inspection, by the output unit.

15. The sheet feeding apparatus according to claim 1,
wherein the torque generated in the driving unit is a conveyance torque output by the driving unit.

16. The sheet feeding apparatus according to claim 1, further comprising:
a drive control unit configured to control the driving unit by generating a control current to be applied to the driving unit based on a command value input from the control unit,
wherein in a case where it is determined that feeding of the sheet by the sheet feeding unit is defective and the control current during the feeding of the sheet is greater than the threshold value, the control unit is configured to
output information on a notification prompting inspection by the output unit.

17. A sheet feeding apparatus comprising:
a sheet support unit configured to support a sheet;
a sheet feeding unit including a rotary feeding member configured to feed the sheet supported by the sheet support unit, and a driving unit configured to drive the rotary feeding member;
a control unit configured to control the driving unit;
a drive control unit configured to control the driving unit by generating a control current to be applied to the driving unit based on a command value input from the control unit, and
an output unit configured to output information,
wherein in a case where it is determined that feeding of the sheet by the sheet feeding unit is defective and the control current during the feeding of the sheet is greater than a threshold value, the control unit is configured to output information on a notification prompting inspection, by the output unit.

18. An image reading apparatus comprising:
the sheet feeding apparatus according to claim 1; and
a reading unit configured to read an image on the sheet fed by the sheet feeding apparatus.

19. An image forming apparatus comprising:
the image reading apparatus according to claim 18; and
an image forming unit configured to form an image on a sheet.

20. An image forming apparatus comprising:
the sheet feeding apparatus according to claim 1; and
an image forming unit configured to form an image on a sheet.
